(19) United States
(12) Patent Application Publication
(10) Pub. No.: US 2013/0022853 A1
(43) Pub. Date: Jan. 24, 2013

(54) Modular Variable Compression Thermal Management Battery Retaining System

(71) Applicant: Robb Protheroe, San Rafael, CA (US)

(72) Inventor: Robb Protheroe, San Rafael, CA (US)

(21) Appl. No.: 13/187,427

(22) Filed: Jul. 20, 2011

(51) Int. Cl. H01M 10/50

(52) U.S. Cl. 429/120

(57) ABSTRACT

The present invention provides a mechanically and thermally improved containment system for rechargeable batteries comprising battery retaining troughs having adjustable compression elements integrated with passive thermal balancing elements. The system is modular such that each individual battery retaining trough can be coupled to any number of other said troughs to provide a battery pack of any desired voltage.

### FIELD OF THE INVENTION

The present invention relates to power storage systems for hybrid vehicles. More specifically the present invention relates to the retention, packaging, and thermal management of add-on, rechargeable battery systems that augment the onboard propulsion battery electric power storage in a hybrid vehicle.

### BACKGROUND OF THE INVENTION

Increased awareness of the dangers of air pollution, greenhouse gas emissions, and the danger of global warming has galvanized the car buying public toward a desire for more fuel efficient vehicles. Millions of hybrid cars are currently in use. These vehicles have very small onboard high voltage power storage systems to run the electric propulsion motor. These relatively small battery banks only allow the hybrid vehicles to travel a short distance in electric-only mode, and the cars typically only achieve fuel efficiency of 50 miles per gallon at best.

Add-on, plug-in rechargeable battery packs are now being sold as retrofits for existing hybrid vehicles. All of these battery systems are subject to variations in temperature because of the size limitations in the areas of the hybrid vehicles where they must be mounted—since the vehicles were not originally designed for the additional battery packs. None of these aftermarket add-on systems, other than the present invention, have taken into account the need for precise thermal balancing and rigid containment to insure the safety of the passengers and the vehicle itself in the event of a collision.

Prior related art includes US patents issued to Ovshinsky et al.—said patents numbered U.S. Pat. No. 7,217,473 issued May 15, 2007, U.S. Pat. No. 6,878,485 issued Apr. 12, 2005, and U.S. Pat. No. 6,372,377 issued Apr. 16, 2002. This last patent is the most similar patent to the present invention, however, all are titled “Mechanical and thermal improvements in metal hydride batteries, battery modules, and battery packs”. These patents specifically focus on providing complex active cooling and containment for a fairly narrow range of battery types.

Lithium Iron Phosphate batteries (LFE) are superior to Nickel metal hydride batteries (“NiMH batteries”), which are in turn far superior to lead acid batteries. LFE batteries are non flammable and non explosive, and are the current desired choice for add-on hybrid battery packs. The present invention is intended to be useful for containment and thermal management of LFE, or any type of battery that may be in use currently or developed at a future date.

Electric vehicle battery systems require thermal management because individual cells are bundled together in close proximity and many cells are electrically and thermally connected together. Significant heat is generated during charge and discharge in all electrical battery systems, but thermal management is particularly important in LFE battery systems. This is because individual LFE cells have an inherent tendency to charge and discharge at slightly different rates—said rates being exaggerated in the context of wide temperature variations between battery cells, and these batteries always require a sophisticated battery management system to function properly. The present invention provides a novel and unique means to thermally manage and balance any battery pack to optimize the efficiency of the battery management system.

There is a need for a universal battery pack system which incorporates the thermal management and structural battery retention required for successful retrofitting and usage in hybrid electric vehicles, while optimizing energy storage capacity, increasing battery reliability, and decreasing the cost. The present invention satisfies that need.

### SUMMARY OF THE INVENTION

The preferred embodiment of the present invention provides an integrated, modular battery containment system that mechanically organizes and restrains, and thermally balances battery packs of virtually any size, voltage, and battery type including cylindrical, prismatic, and envelope packaging.

Another preferred embodiment of the present invention is to add battery power to an automobile using a plurality of batteries which may be enclosed in an aluminum enclosure. Lithium type batteries as currently available by manufacturers in essentially rectangular prismatic, soft envelope, or rolled cylindrical shapes, may be positioned abutting one another in rows in channels in an enclosure and compressed against one wall of the enclosure by a compression plate held in place by a pressure bolt in the opposite side of the enclosure. This may maintain the integrity of the batteries during use when temperature variations occur. The enclosure may additionally provide thermal conductivity for the purposes of heating and cooling.

### BRIEF DESCRIPTION OF THE DRAWINGS

FIG. 1 is an exploded isometric view of a single channel battery retaining trough assembly as disclosed in the present invention.

FIG. 2 is an isometric view of an exemplary battery channel trough containment case as disclosed in the present invention.

FIG. 3 is an isometric view of an exemplary battery channel containment case as disclosed in the present invention showing multiple battery cells in place.

FIG. 4 is an isometric view of an exemplary battery channel containment case as disclosed in the present invention showing multiple battery troughs in place.

### DETAILED DESCRIPTION OF THE INVENTION

All element identification numbers for substantially similar elements are used in all the drawings. In some drawings, element numbers are left out for clarity and minimization of redundancy.

The preferred embodiment of the present invention provides a modular variable compression thermal management battery retaining system which may include a battery channel case 6 that is configured to retain one or a plurality of battery channel 8 units.

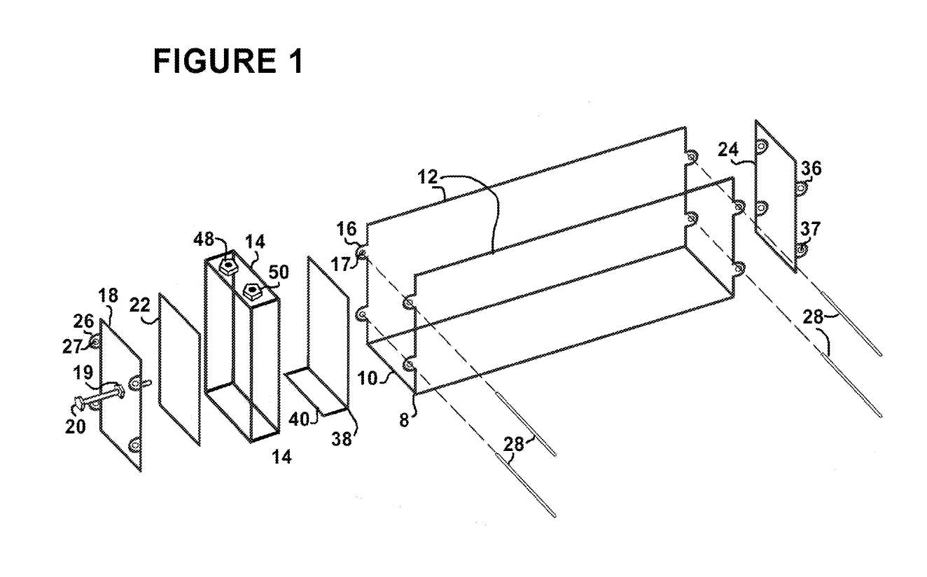

As depicted in the exploded view in FIG. 1, each battery channel 8 is configured as a “U” shaped vessel formed with a squared or rounded base 10 integrated with two vertical walls 12. The actual physical transition from base 10 to walls 12 may be sharp or contoured depending on the shape of a given battery cell 14 to be constrained in any said channel 8. Channel 8 may be open at the top, and incorporate a plurality of perpendicular tabs 16 at either end. Said tabs 16 may further incorporate a hole 17 placed substantially at the center of any of said tab 16.

A pressure adjusting plate 18 may be made from the same material as any channel 8 and dimensioned to fit easily within either end of any channel 8 with a clearance that may be one sixteenth inch in any dimension. Adjusting plate 18 may be fitted along its vertical midline axis with at least one fixed nut 19 which may be welded or otherwise fixedly attached to said adjusting plate 18. Pressure adjusting plate 18 may incorporate tabs 26 and holes 27 positioned to line up with all tabs 16 and holes 17 incorporated into any channel 8.

Pressure adjusting bolt 20 may be threadably mounted through any said nut 19 to provide variable pressure on any moveable plate 22 which is initially loosely placed against the outer surface of any first battery cell 14 in said channel 8. Moveable plate 22 may be made from the same material as any pressure adjusting plate 18 and dimensioned to fit easily within either end of any channel 8 with a clearance that may be one sixteenth inch in any dimension.

A lock plate 24 is also substantially dimensionally similar to adjusting plate 18 and moveable plate 22. Lock plate 24 incorporates tabs 36 and holes 37 which are substantially identical in shape and position on said lock plate 24 such that said tabs 36 and holes 37 will line up with tabs 16 and 17 at the opposite end of any channel 8 wherein any adjusting plate 18 is placed.

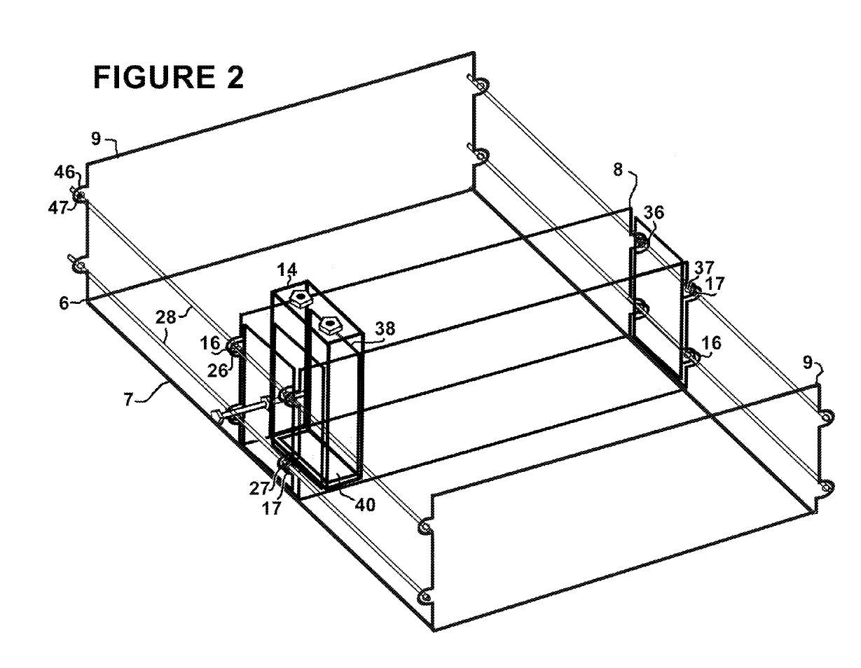

Another element of the preferred embodiment of the present invention as depicted in FIG. 1 is the “L” shaped thermal wick plate 38. As shown more clearly in FIG. 2, wick plate 38 is shown placed adjacent to a battery cell 14, and with the lower leg 40 of said wick plate 38 located under any said battery cell 14 such that lower leg 40 of thermal wick plate 38 is secured against said channel 8 base 10 by the weight and position of said battery cell 14. This physical arrangement allows thermal transfer between said battery cell 14, said channel 8, and said case 6.

Also shown in FIG. 2, said case 6 may preferably be formed from any material which is thermally conductive, mechanically strong and rigid, and may be chemically inert to the battery chemistry of any battery cell 14 contained within said channel 8. A metal, polymer, or composite material may be used as the material for the case 6. However, in choosing such a material, consideration must be given to thermal heat transfer.

Most preferably, case 6 is configured as a “U” shaped vessel formed having a squared base 7 and two vertical walls 9. The actual physical transition from base 7 to walls 9 may be sharp or contoured. Channel case 6 is also fitted with tabs 46 and holes 47 such that when any channel 8 is placed within said case 6, said tabs 46 and holes 47 will line up with tabs 16, 26, and 36, and holes 47 will line up with holes 17, 27, and 37.

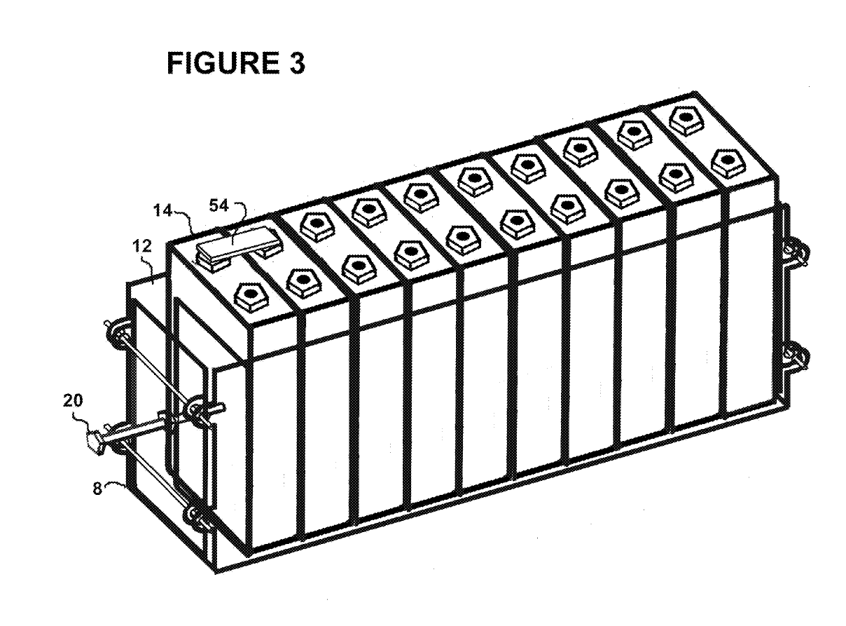

Locking rods 28 are aligned through all said tabs 16, 26, 36, and 46, and holes 17, 27, 37, and 47 to create a fully locked space frame effect when any channel 8 is filled with battery cells 14—as shown in FIG. 3—and pressure adjusting bolts 20 are tightened.

The Case 6 assembly is configured such that all battery cells 14 are bound together under external mechanical compression within any channel 8 such that they are secure and do not move around or dislodge when subjected to the mechanical vibrations of transport or use.

As shown in FIGS. 1 and 2, the wick plate 38 transfers temperatures from the individual battery cells 14 to the channel 8 and into the case 6—providing essentially a giant heat or cold sink for the entire battery system. Further, ambient heat or cold can be transferred back into the battery cells 14 through the same thermal transfer path.

As depicted in FIG. 3, any number of battery cells 14 may be bundled into a channel 8, depending on the desired length of any said channel 8. The battery cells 14 are preferably electrically interconnected by a conductive lead connection strap 54 which provides a low resistance pathway from a positive terminal 48 to a negative terminal 50 on an adjacent other battery cell 14. However, said strap 54 is well known in prior art so there is no need to go into detail herein.

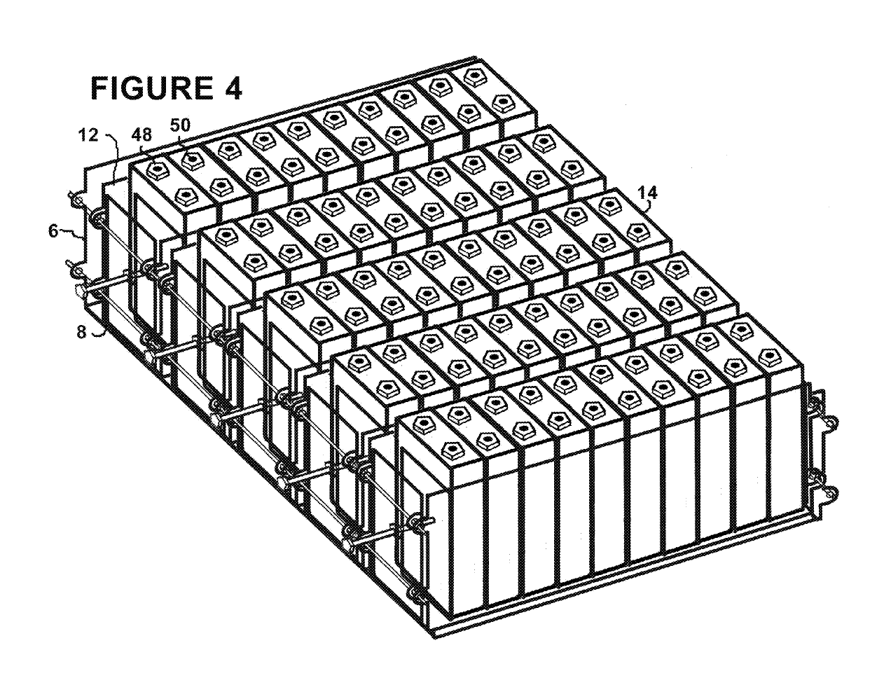

As depicted in FIG. 4, a plurality of channels 8 are constrained in case 6 per the present invention. The maximum number of channel 8 units incorporated into a case 6 is only limited by the available space in a vehicle (not shown in the figure) intended to house said case 6. Preferably the battery cells 14 are bundled such that they are all oriented in the same direction with each battery cell 14 having its electrical positive terminal 48 and negative terminal 50 located on top. The battery cells 14 are oriented within a channel 8 such that their narrowest sides face the vertical sides 12 of channel 8 and their wider sides (those which, on expansion of the batteries, will warp) are placed adjacent to other batteries 14 in the channel 8. This arrangement permits expansion in only one direction within the channel 8.

During cycling of the battery cells 14, they may generate waste heat. This is particularly true during charging of the battery cells 14. This excess heat can be destructive to a battery system. Some of the negative characteristics which are encountered when a battery pack system has improper thermal management include substantially lower capacity and power, substantially increased self discharge, imbalanced temperatures between batteries and modules leading to battery abuse, and lowered cycle life of the batteries. Therefore, it is clear that to be optimally useful, battery pack systems need proper thermal management.

Typically, hybrid vehicles already incorporate air blowers to cool the onboard battery pack, and the present invention is designed too utilize this existing airflow to aid in managing the thermal balancing of the add-on battery pack contained within the present invention. The use of a fan in the present invention is optional and well known in prior art—so a fan is not shown in the figures—but a fan may be beneficial in terms of maintaining optimal pack temperature which aids in optimization of pack performance and life.

In addition to cooling the battery pack when it is hot, said wick plate(s) 38 can heat the battery pack when it is too cold. That is, if the battery pack is below its minimum optimal temperature, and the ambient air is warmer than the battery pack, said wick plate(s) 38 may be turned on to draw warmer ambient air into the battery pack. The warmer air then transfers its thermal energy to the battery pack and warms it to at least the low end of the optimal range of temperature.

Air is the most preferred coolant (since it is readily available and easy to transport into and out of the case). Since the present invention is intended to be utilized in conjunction with add-on battery packs retrofitted to hybrid vehicles, it is important that the cooling system be as simple and effective as possible.

The compressed channel 8 design results in even cooling, and reducing the influence of other flow restrictions (such as inlets or exits) which could otherwise produce non uniform air flow between the battery cells 14. Furthermore, the same area of each battery cell 14 is exposed to a thermal balancing effect with similar velocity and temperature.

To assist in achieving and maintaining the proper spacing of the battery cells 14 within a channel 8 and to provide electrical isolation between the battery cells 14 and the vertical walls 12 of any channel 8, each of said walls 12 are sized to be lower than the height of the conductive lead connection strap 54, or a positive terminal 48 or a negative terminal 50.

The disclosure set forth herein is presented in the form of detailed embodiments described for the purpose of making a full and complete disclosure of the present invention, and such details are not to be interpreted as limiting the true scope of the invention as set forth and defined in the claims below.

I claim:

1. A Modular Variable Compression Thermal Management Battery Retaining System Including the following elements:
at least one battery cell retaining channel formed into a substantially “u” shape and configured with a plurality of tabs at the outer ends of the vertical walls of said at least one battery cell retaining channel, each of said plurality of tabs having centrally punched holes;
at least one first end plate having a vertical face, and configured with a plurality of tabs formed perpendicularly to said vertical face with each of said plurality of tabs having centrally punched holes;
at least one second end plate having a vertical face, and configured with a plurality of tabs formed perpendicularly to said vertical face with each of said plurality of tabs having centrally punched holes;
at least one lock plate substantially similar in size and shape to said second end plate, and without said tabs;
said at least one first end plate having at least one threadably mounted bolt that can be adjusted;
a plurality of locking rods that may be inserted and aligned into said plurality of holes in said plurality of said tabs in said at least one battery cell retaining channel, said at least one first end plate, and said at least one second end plate;
wherein, when said at least one battery cell retaining channel is filled with battery cells, and said at least one first and second end plates are aligned and fitted with said plurality of said locking rods, and said at least one threadably mounted bolt is adjusted tightly against said lock plate, a rigid space frame is formed.

2. A Modular Variable Compression Thermal Management Battery Retaining System according to claim 1 that incorporates at least one “L” shaped thermal wick plate that is essentially similar in size and shape to said lock plate with the addition of a right angle tab formed at its base such that said base may be fitted under any of said battery cells, such that said thermal wick plate provides added thermal dissipation for said batteries within said channel.

3. A Modular Variable Compression Thermal Management Battery Retaining System according to claim 1 that is configured from electrically non-conductive materials.

4. A Modular Variable Compression Thermal Management Battery Retaining System according to claim 1 that is configured from electrically conductive materials.

5. A Modular Variable Compression Thermal Management Battery Retaining System according to claim 1 that further includes a substantially “u” shaped member that is capable of housing a plurality of said at least one battery cell retaining channels, said substantially “u” shaped member configured with a plurality of tabs at the outer ends of its vertical walls, each of said plurality of tabs having centrally punched holes, and wherein said tabs and holes line up with all other referenced tabs and holes in claim 1.
